(19) United States
(12) Patent Application Publication
(10) Pub. No.: US 2009/0249400 A1
(43) Pub. Date: Oct. 1, 2009

(54) SYSTEMS AND METHODS FOR PROVIDING ON-DEMAND MEDIA CONTENT

(75) Inventors: Marvin Charles Carlberg, Los Angeles, CA (US); Khalil Haj-khalil, Tarzana, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/059,825

(22) Filed: Mar. 31, 2008

Related U.S. Application Data
(60) Provisional application No. 61/039,821, filed on Mar. 27, 2008.

(51) Int. Cl. G06F 3/00

(52) U.S. Cl. 725/44; 725/87

(57) ABSTRACT

A media guidance application having a media content search function is implemented on a plurality of user equipment devices. Search-related communications from users are received and analyzed to identify a media content not currently available via the media guidance application. Once a media content has been identified from at least a threshold number of search-related communications, the media content is offered via the media guidance application. An alert or notice may then be sent to users of the media guidance application, and especially those users who requested the media content, to notify them of the availability of the media content.

This application claims the benefit of U.S. Provisional Application No. 61/039,821, filed Mar. 27, 2008, the disclosure of which is hereby incorporated by reference herein in its entirety.

### BACKGROUND OF THE INVENTION

Embodiments of the invention relate generally to media systems and methods, and more particularly, to media systems and methods for providing on-demand media content.

Many people prefer to watch movies at home rather than at theaters. Unfortunately, by the time movies are broadcast or otherwise provided by television networks and other providers, they are typically a few months to a few years old. More recent movies can be purchased or rented on DVDs and other storage mediums, but this requires driving to retail or movie rental stores or joining movie rental clubs. Made-for-TV movies are of course broadcast by television providers more quickly, but many people prefer to watch theatrical motion pictures over made-for-TV movies.

Video on demand (VOD) systems were developed to allow people to watch theatrical movies at home without the inconveniences of obtaining and returning them. VOD systems provide movies and other content over a network or an interactive television system. VOD systems either stream media content, allowing viewing in real time, or download it to a set-top box before viewing starts. The majority of cable and telco based VOD systems use the streaming approach, whereby a user buys or selects a movie or television program and begins watching it immediately. With the proliferation of computers and wireless devices, VOD systems now encompass a broader spectrum, permitting delivery of media content to not only set-top-boxes but also computers, mobile phones and any system that can receive on-demand content over a network.

Although watching movies via VOD systems is more convenient than buying or renting DVDs, the selection of available VOD media content is often poor because it is too costly and time-consuming for VOD providers to simultaneously obtain the necessary licenses for lots of movies. Moreover, media content providers only allocate a certain amount of bandwidth for VOD content. VOD providers therefore must anticipate the demand for particular movies and offer only the most popular ones. This is a difficult task because a movie that was popular at theaters may not be as popular via VOD because of demographic and other differences between theater-goers and stay-at-home viewers.

### SUMMARY OF THE INVENTION

Embodiments of the present invention solve the above-described problems and provide enhanced systems and methods for providing on-demand media content. In general, embodiments of the invention permit media content providers to offer on-demand media content based on actual viewer requests.

In an exemplary embodiment, a media guidance application having a media content search function is implemented on a plurality of user equipment devices such as televisions with set-top boxes. Search queries or other search-related communications from users are received and analyzed to identify a media content not currently available via the media guidance application. The search-related communications may be analyzed to identify media content based on titles, contents, actors, or any other searchable attribute. The search-related communications may be analyzed by the media guidance application or by a computing device in communication with the media guidance application.

Once a media content has been identified from at least a threshold number of search-related communications, the media content is offered via the media guidance application on an on-demand basis. For example, if 5 search-related communications identify the movie “Dodgeball” and 50 search-related communications identify the movie “40-Year-Old Virgin,” the latter movie may be offered but not the former one. An alert or notice may then be sent to users of the media guidance application, and especially those users who requested the media content, to notify them of the availability of the media content.

In another embodiment, a system for providing on-demand media content is provided. The system may comprise control circuitry and a media source. The control circuitry is operable to implement a media guidance application having a media content search function and to receive search-related communications from users of the media content search function. The media source is operable to analyze the search-related communications, identify a media content not currently available via the media guidance application, and offer the media content on an on-demand basis to the users of the media guidance application once the media content has been identified from at least a threshold number of search-related communications. The media source may be a media content source consisting of a television distribution facility, a cable system headend, or a satellite distribution facility. Alternatively, the media source may be a media guidance data source that provides media guidance data to the media guidance application.

The above-described embodiments and other embodiments of the invention are at least partially implemented with an interactive media guidance application. An interactive media guidance application allows a user to more easily navigate through the wide array of media content accessible by a typical user equipment device by displaying media content listings. The media content listings may be television program or movie listings and may list the titles of the programs and movies, their broadcast times, and other relevant information. A user may select to view the media content described by a listing by highlighting the media content listing and pressing an “Enter” or “Select” button on a remote control device or other input device. The media guidance application then tunes a receiver to the appropriate channel.

An interactive media guidance application may also perform one of several media guidance application functions on content accessible by a user equipment device. These media guidance application functions may include the searching functions described above, scheduling a selected content to be recorded, recording the selected content to a local storage device or remote media server, adding the selected content to a favorite programs list, setting a reminder for the selected content, ordering the selected content via an on-demand (e.g., video on-demand or VOD) or pay-per-view (PPV) service, or any other suitable function.

Other embodiments of the invention identify and provide desired media content without a media guidance application. Instead, user requests, search queries, or other search-related communications are received via e-mail or other communication methods. As with the previously-described embodiments, the search-related communications are analyzed to identify a media content not currently broadcast or otherwise available. Once a media content has been identified from at least a threshold number of search-related communications, the media content is offered on an on-demand basis.

These and other important aspects of the present invention are described more fully in the detailed description below.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings in accordance with an embodiment of the invention;

FIG. 2 shows another illustrative display screen that may be used to provide media guidance application listings in accordance with an embodiment of the invention;

FIG. 3 shows an illustrative user equipment device in accordance with an embodiment of the invention;

FIG. 4 is a diagram of an illustrative interactive media system in accordance with an embodiment of the invention;

FIG. 5 shows an illustrative display screen that may be used to select a search function of a media guidance application;

FIG. 6 shows an illustrative display screen that may be used to select search options of a media guidance application search function;

FIG. 7 shows an illustrative display screen that may be used to spell or otherwise enter a keyword for a search function;

FIG. 8 shows an illustrative display screen that may be used to select a category for a keyword search;

FIG. 9 shows an illustrative display screen that may be used to display matches for a keyword search;

FIG. 10 shows an illustrative display screen that may be used to request a currently unavailable media content;

FIG. 11 shows an illustrative display screen that may be used to alert users of the availability of a desired media content;

FIG. 12 shows an illustrative process for requesting media content in accordance with another embodiment of the invention;

FIG. 13 shows another illustrative process for requesting media content in accordance with an embodiment of the invention.

### DETAILED DESCRIPTION OF THE PREFERRED EMBODIMENTS

The amount and variety of media content available to viewers has increased dramatically in recent years. In addition to hundreds of conventional broadcast television channels, consumers may now access a nearly limitless amount of video and other content via computers, mobile phones, and other wired and wireless broadband devices. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

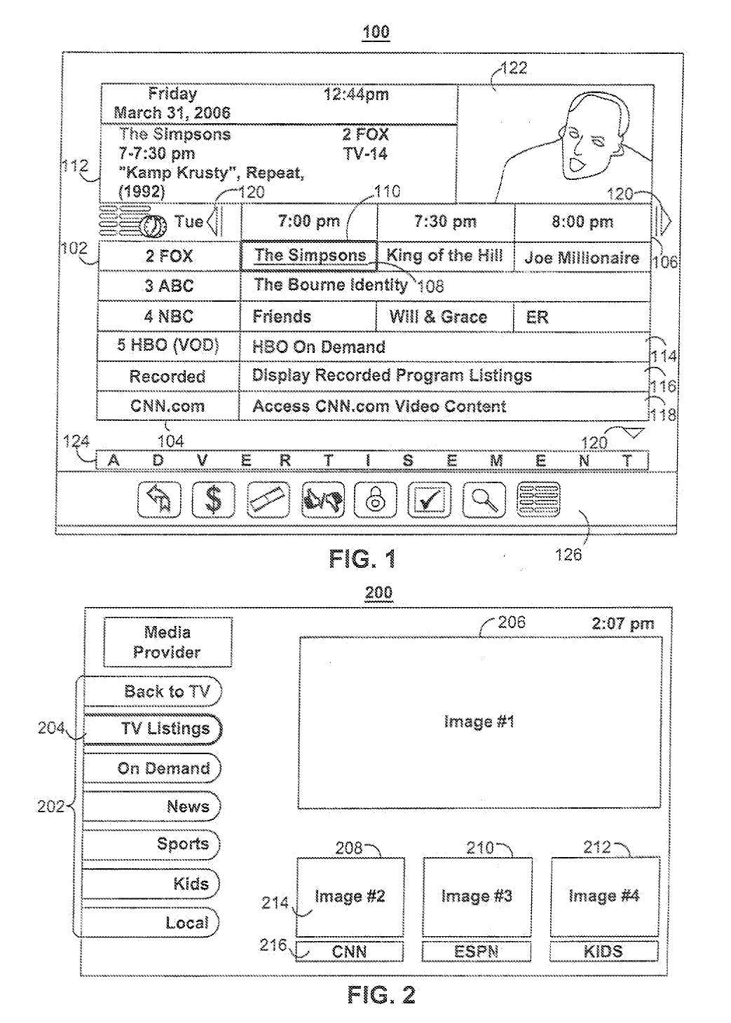

One of the functions of the media guidance application is to provide media listings and media information to users. FIGS. 1-2 show illustrative display screens that may be used to provide media guidance, and in particular media listings. The display screens shown in FIGS. 1-2 and FIGS. 5-11 may be implemented on any suitable device or platform. The displays of FIGS. 1-2 and FIGS. 5-11 may be full screen displays or may be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

Users may access media content and the media guidance application (and its display screens described above and below) from one or more of their user equipment devices. The user equipment devices may be personal computers, televisions, or any other devices. For example, one user equipment device may be a personal computer provided with a tuner card that allows TV signals to be displayed on the computer monitor. The user equipment device may also be television equipment with a set-top box or receiver that permits access to the Internet via a cable connection phone line, or other communication line.

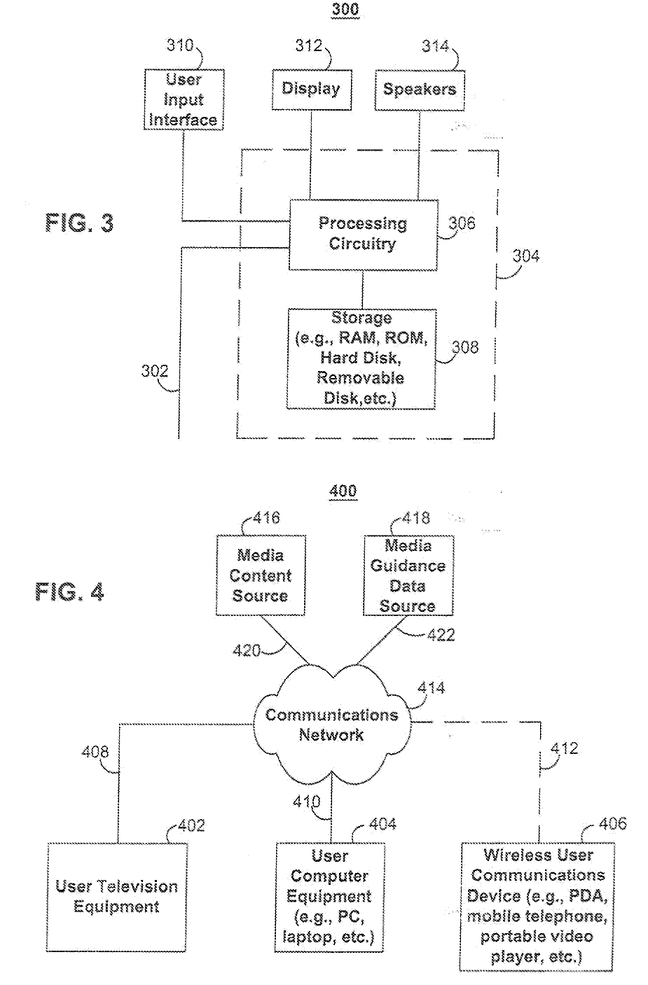

FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one or two source devices. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user equipment device 300 may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user equipment device 300 directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

The above-described media guidance application, user equipment device 300, system 400, or similar devices and equipment may be used to implement systems and methods for providing on-demand media content. In general, embodiments of the invention permit media content providers to offer on-demand media content based on actual viewer requests.

In an exemplary embodiment, a media guidance application having a media content search function is implemented on a plurality of user equipment devices such as televisions with set-top boxes. Search queries, keywords, or other search-related communications are received from users and analyzed to identify a media content not currently available via the media guidance application. The search-related communications may be analyzed to identify media content based on titles, contents, actors, or any other searchable attribute. The search-related communications may be analyzed by the media guidance application or by a device or system in communication with the media guidance application.

Once a media content has been identified from at least a threshold number of search-related communications, the media content is offered via the media guidance application on an on-demand basis. For example, if 5 search-related communications identify the movie “Dodgeball” and 50 search-related communications identify the movie “40-Year-Old Virgin,” the latter movie may be offered but not the former one. An alert or notice may then be sent to users of the media guidance application, and especially those users who sent the search-related communications, to notify them of the availability of the media content.

In other embodiments, desired media content may be identified without a media guidance application. Instead, user requests, search queries, or other search-related communications are received via e-mail, instant messaging, or other communication methods. The search-related communications may be entered with any suitable device including mobile phones, landline phones, personal computers, web-enabled portable devices, etc.

As with the previously-described embodiment, the search-related communications are analyzed to identify a media content not currently available via the media guidance application. Once a media content has been identified from at least a threshold number of search-related communications, the media content is offered on an on-demand basis.

In some embodiments, on-demand media content includes movies, sporting events, recorded concerts, and other media content offered via video-on-demand (VOD) or pay-per-view (PPV) services. In other embodiments, the on-demand media content may include certain broadcast movies, programs, or other media content. For example, the ABC network (or any other broadcast network) could solicit and receive search requests or other search-related communications over a period of time and analyze the communications to choose a movie for its Friday Night At The Movies. The network could also select and display targeted advertising during the movie based on the search-related communications or the selected movie itself and even charge a premium fee for the targeted advertising.

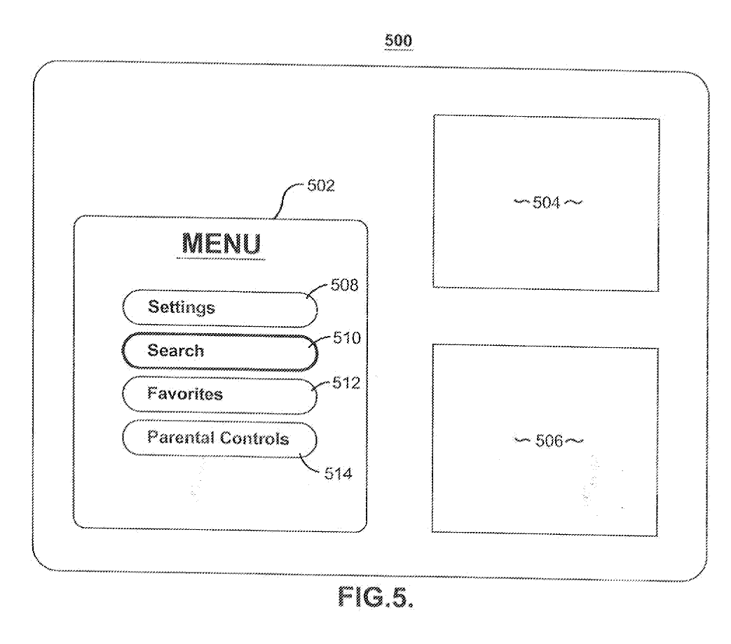

FIG. 5 illustrates an exemplary menu display screen 500 that may be used to access a media content search function of the media guidance application. The display screen 500 may be displayed whenever a user presses a Menu button or other button on the user input interface 310 or other control device. The display screen 500 may include a Menu region 502 for displaying menu options, a Media Content region 504 for displaying TV programs or other media content, and an Advertising region 506 for displaying advertisements.

The Menu region 502 may include selections for Settings 508, Search 510, Favorites 512, Parental Controls 514, and possibly other menu categories. A user may navigate between any of these selections with the user input interface 310. For example, the user may press the arrows or other buttons on the user input interface 310 to move a highlight or bold region (which is shown on the Search selection 510) about the display screen 500 and may then press an Enter button or similar button to enable the highlighted selection.

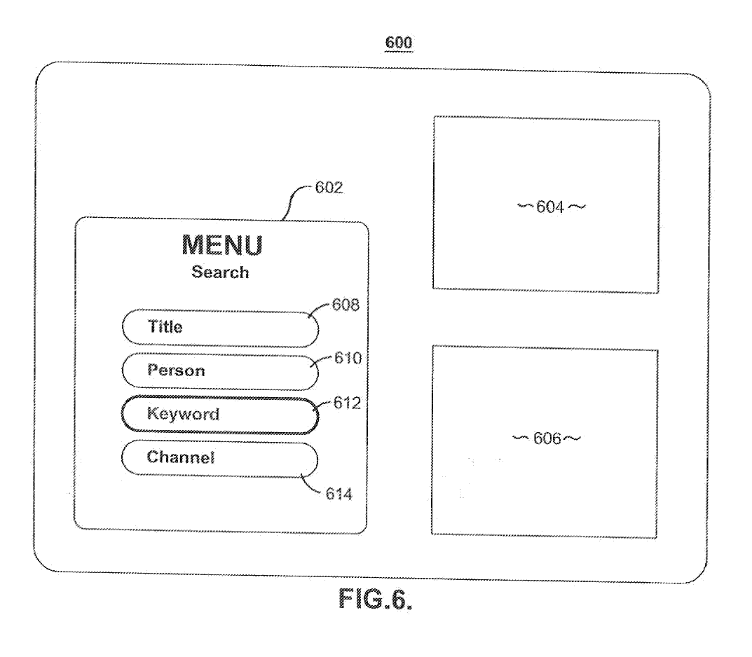

After selecting the Search selection 510, a listing of search categories or options may be displayed. For example, the menu screen 600 shown in FIG. 6 may be displayed. As with screen 500, menu screen 600 may include a Menu region 602 for displaying menu options, a Media Content region 604 for displaying TV programs or other media content, and an Advertising region 606 for displaying advertisements. The Menu region 602 may include selections for Title 608, Person 610, Keyword 612, Channel 614, and possibly other categories. Again, a user may navigate between the selections and pick one by placing a highlight region over the requested selection and pressing Enter or another button on the user input interface 310.

The Title selection 608 permits a user to search for desired media content by comparing search-related communications to known media content titles. For example, if a user enters the word “Identity”, the media guidance application may search its media guidance data in an attempt to locate all media content having a title containing this word and may return listings for the movies “The Bourne Identity”, “Identity”, and “Secret Identity Crisis”. The user may also be presented with an option to narrow the search to only movies, television programs, sporting events, etc. so that only certain categories of media content is searched.

The Person selection 610 permits a user to search for media content starring a particular actor or actress. For example, if a user enters the name “Bolin”, the media guidance application may search its media guidance data and return listings of movies starring Josh Bolin or James Bolin. Again, the user may be presented with an option to narrow the search to only movies, television programs, sporting events, etc. so that only certain categories of media content is searched.

The Keyword selection 612 permits a user to search for desired media content based on entered keywords. To permit keyword searching, each media content accessible via the media guidance application is associated with certain keywords or attributes. For example, the movie “No Country for Old Men” may be associated with the keywords “Jones,” “Bardem,” “Coen,” “crime,” “Oscar,” and “McCarthy,” to identify two of the movie's actors, the director, a movie category, the Oscar award, and the writer of the related book, respectively. The keywords or attributes for each media content may be stored in a searchable database or may be stored as metadata that is embedded in the media content or media guidance data for the media content.

When a user enters a keyword, it is compared to the searchable database and/or metadata in an attempt to locate media content associated with the same or similar keywords or attributes. For example, if a user enters the word “country”, the media guidance application may search its media guidance data and return results for the movies “No Country for Old Men” as well as several other movies with “country” themes. Again, the user may be presented with an option to narrow the search to only movies, television programs, sporting events, etc. so that only certain categories of media content is searched.

The Channel selection 614 permits a user to search for desired media content on specific TV channels. For example, a user may search for particular movies or other media content broadcast on HBO.

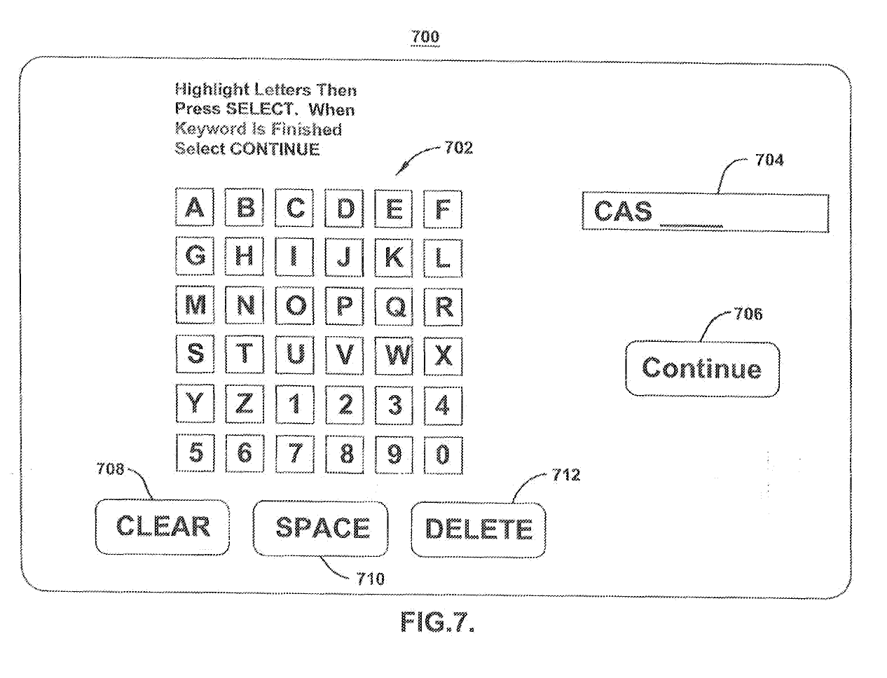

After selecting one of the selections 608, 610, 612, or 614 from menu screen 600, the user may be presented with a display screen that permits entry of a search query, keyword, or other search-related communication. For example, after selecting the highlighted Keyword selection 612, the display screen 700 shown in FIG. 7 may be displayed. The display screen 700 may include alphanumeric keys or buttons 702 that can be selected by placing a highlight region or cursor over a requested letter or number and then pressing Enter, Select, or another button on the user input device 310. Selected letters are then displayed in an input area 704. Once a keyword has been spelled in the input area 704, the user may enter it by pressing a Continue button 706. The display screen 700 may also include a Clear button 708 that clears a selected letter or other character from the input area 704, a Space button 710 that inserts a space into the input area 704, and a Delete button 712 that deletes all letters from the input area 704.

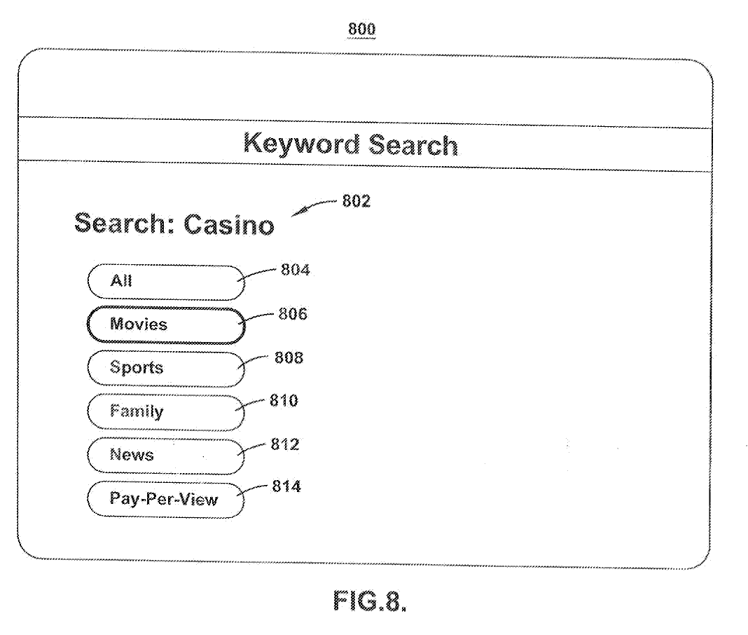

After a keyword, search query, or other search-related communication is entered in input area 704 or elsewhere, a listing of search categories or options may be displayed. For example, the menu screen 800 shown in FIG. 8 may be displayed. Menu screen 800 may include a search description area 802 that lists an entered search-related communication and a Menu region 804 for displaying search options. The Menu region 804 may include an All selection 804 that compares the entered search-related communication to all known media content, a Movies selection 806 that compares the search-related communication to known movies, a Sports selection 808 that compares the search-related communication to sports-related media content, a Family selection 810 that compares the search-related communication to family-oriented media content, a News selection 812 that compares the search-related communication to news-related media content, and a Pay-Per-View selection 814 that compares the search-related communication to on-demand media content. Again, a user may navigate between the selections and pick one by placing a highlight region over the requested selection and pressing Enter or another button on the user input interface 310.

After a user has entered a keyword, search query, or other search-related communication via the display screen 700 or by another method, and after the user has selected a search category via the display screen 800 or by another method, the search-related communication is compared to available media content in an attempt to find one or more matches. In one exemplary embodiment, the media guidance application performs the comparison functions by comparing the search-related communication to media guidance data provided by the media guidance data source 418. For example, the media guidance application may compare the search-related communication to metadata accompanying or embedded in the media guidance data. In other exemplary embodiments, the comparison search functions may be performed by the media guidance data source 418, the media content source 416, or another device or system.

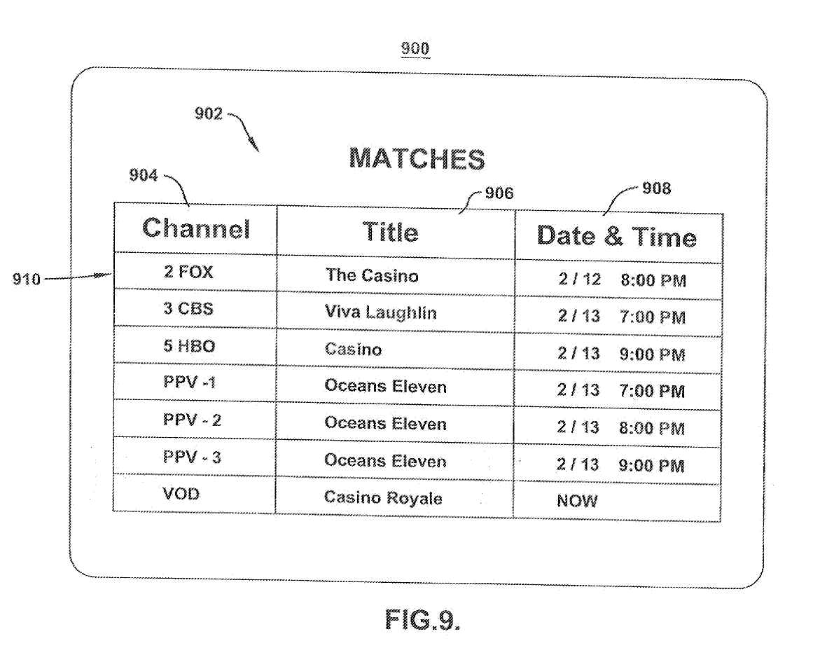

If one or more media contents match or are otherwise related to the search-related communication, listings of the matching media content may be displayed to the user. FIG. 9 illustrates an exemplary display screen 900 that may be displayed to show media content that matches a search request. The display screen may include a data table or grid 902 with a Channel column 904 that indicates the channel or other source of matching media content, a Title column 906 that indicates the titles or other identifying information for matching media content, and a date/time column 908 that indicates the broadcast times or availability times of the matching media content. For example, the first row 910 of the grid 902 indicates that the program “The Casino” matches a search-related communication and is broadcast or otherwise provided by Fox on February 12 at 8:00 P.M.

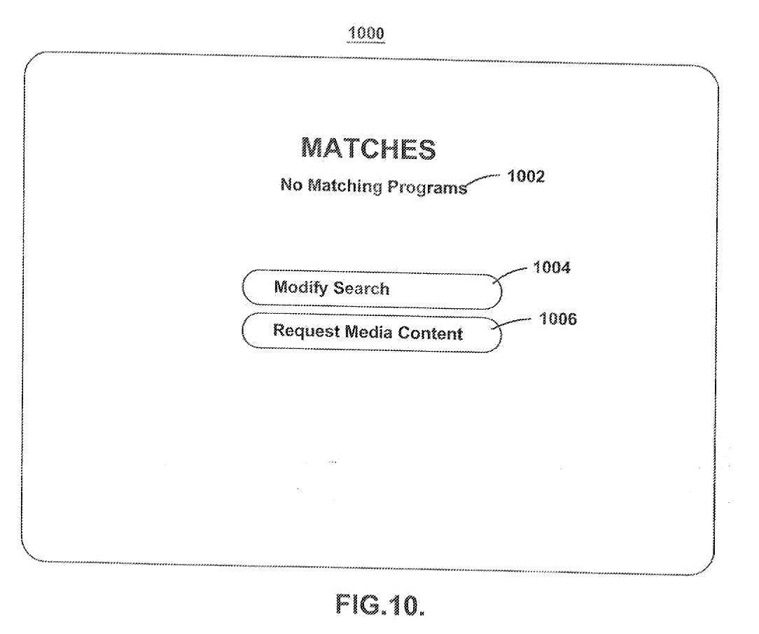

If no matching media content is found, the user may be presented with additional searching options. For example, an exemplary menu screen 1000 shown in FIG. 10 may be displayed. The menu screen 1000 may include a message area 1002 that indicates no matching media content was found and selections for Modify Search 1004 and Request Media Content 1006. A user may navigate between the selections and pick one by placing a highlight region over the requested selection and pressing Enter or another button on the user input interface 310.

The Modify Search selection 1004 returns the user to display screen 700, display screen 800, or another screen to permit the user to enter different search terms, to select different media content categories, or to otherwise alter the requested search.

In accordance with an aspect of the present invention, the Request Media Content selection 1006 permits the user to request currently unavailable media content. When a user picks selection 1006, the media guidance application transmits the keyword, search query, or other search-related communication entered by the user to the media guidance data source 418, media content source 416, or to another device or system. For example, if a user enters the keyword “casino” in an attempt to locate a media content as described above, and no currently-available media contents match the keyword, the user may pick the Request Media Content selection 1006 to trigger the media guidance application to send the keyword “casino” to an external device or system. The keyword or other search-related communication is then analyzed in an attempt to locate at least one matching media content not currently provided by the media guidance application. For example, the media guidance data source 418 or other device or system may receive the keyword “casino” from the media guidance application and then compare it to keywords or other attributes assigned to known media content and determine that the keyword “casino” is associated with the following media contents: “Casino” and “Casino Royale”.

Search-related communications may also be received and analyzed without requiring users to affirmatively request media content. Instead, unsuccessful search queries and other search-related communications may be automatically sent to the media guidance data source 418, media content source 416, or to another device or system and then analyzed in an attempt to locate currently unavoidable media content.

In other embodiments, the search-related communications are not entered through the media guidance application. Instead, the communications may be sent directly to the media guidance data source 422 or other device or system via e-mail, text mail, instant messaging, or any other communication method with a mobile phone, landline phone, personal computer, web-enabled portable device, or any other suitable device. In one particular embodiment, a “request line” website such as www.requests.tvguide.com may be established to receive search-related communications. The website itself, or a device or system in communication with the website, may perform the comparison and matching functions described herein. The request line may also simply be an e-mail address, a regular postal address, or even a phone number.

In some embodiments, the request line receives search-related communications from multiple users. Each of the communications is analyzed in an attempt to locate matching media content currently not available via the media guidance application. Once a media content has been identified from a threshold number of search-related communications, an operator of the media content source 416 or another content source may choose to make the media content available to users of the media guidance application.

The threshold number of search-related communications that must be received before a media content is made available to users can be selected based on several factors. For example, the threshold number may simply be a fixed number such as 10, 50, 100, 1,000, or any other number. If the threshold is selected to be 50, a media content is made available to users of the media guidance application after 50 search-related communications identifying the media content are received. Alternatively, the threshold number may be a percentage (e.g. 5%, 10%, 20%, etc.) of the total number of search-related communications received in a given time period. For example, if the threshold percentage is selected to be 10%, and 1,000 search-related communications are received each day (or during any other selected time period), a media content may be made available to users after 100 search-related communications matching the media content are received. In another embodiment, the threshold number may be based on the frequency of search-related communications. For example, a media content may be made available to users if 10, 50, 100, 1,000, or any other number of search-related communications identifying a particular media content are received in a single hour (or any other time period). This embodiment anticipates immediate demand for a media content and may be useful for offering a media content in response to a recent event. For example, if lots of users suddenly request a movie after it wins an Academy Award or is otherwise subject of favorable publicity, this embodiment quickly makes the media content available to the users. Similarly, if a particular celebrity is subject to favorable or unfavorable news reports (e.g. a divorce, sex scandal, etc.), a significant number of search requests may be suddenly received for media content featuring the celebrity. This allows media content providers to quickly gain revenue from a suddenly popular media content.

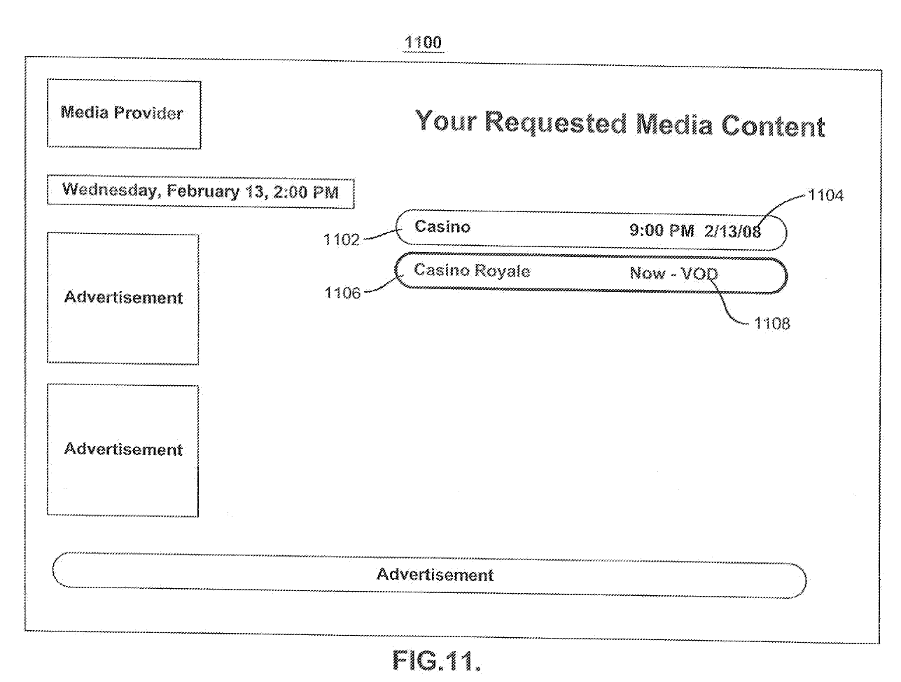

After a media content is made available, the users may be alerted via the media guidance application or by some other method. For example, the media guidance application may display the screen 1100 shown in FIG. 11, which provides listings for all newly-available media content. The media content listings may be accompanied by the media contents' broadcast times and dates. For example, listing 1102 and date marker 1104 show that “Casino” will be broadcast at 9:00 P.M. on Feb. 13, 2008, and listing 1106 and date marker 1108 show that “Casino Royale” is immediately available via VOD.

Users may request to record one of the listed media contents by highlighting the listing and pressing a “Record” or similar button on the user input device 310. The user may later request play-back of a recorded media content by highlighting the media content listing and then pressing “Enter” or another command on the user input device 310. In response to a play-back request, the media guidance application issues a play-back request to either the local storage device 308 or a remote storage device. The play-back request may include an identifier for the media content that the user wishes to play back and an identifier of the user. The play-back request may also include a pointer to a media directory on the local or remote storage device. The local or remote storage device then retrieves the requested media content and provides it to the user equipment device 300 as a suitable signal such as an NTSC video signal or an MPEG-2 video signal. The media content may be transferred to the user equipment device 300 in real time or in a compressed form such as a compressed video file.

Users may also be notified of newly-available media content via e-mail, text messages, instant messages, or any other communication methods.

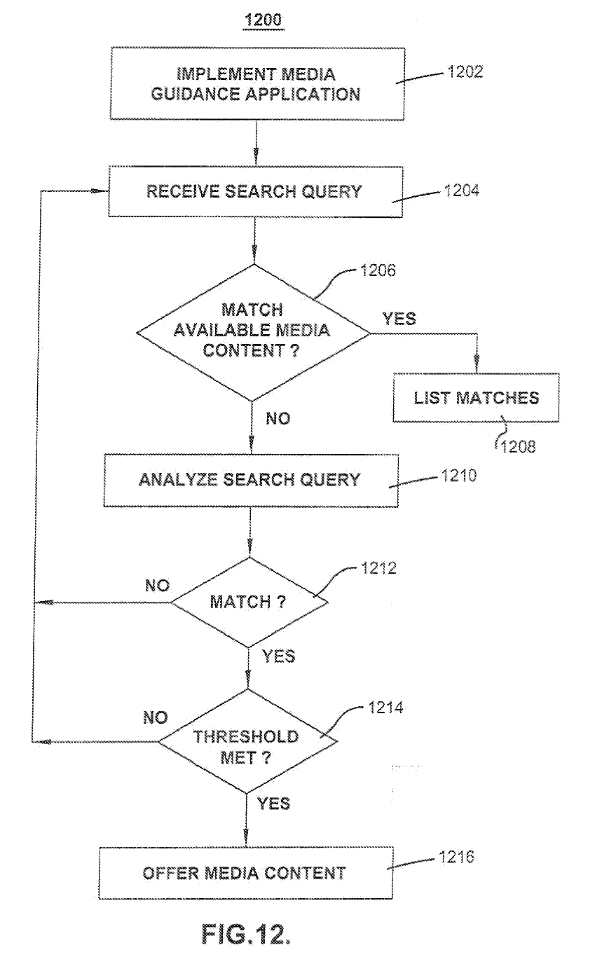

FIG. 12 shows an exemplary process 1200 for providing on-demand media content in response to user requests. In step 1202, a media guidance application is implemented on user equipment device 300 such as a television set-top box. As discussed above, the media guidance application may display media content listings and may perform several media guidance application functions.

In step 1204, a search-related communication is received from a user of the media guidance application. As mentioned above, the search-related communication may be entered on the user equipment device 300 with assistance from the media guidance application.

In step 1206, the search-related communication is compared to media guidance data, metadata embedded in the media guidance data, or other data in an attempt to locate a currently available media content that matches the search-related communication. If one or more matches are found, step 1208 provides listings for the media content. If the search-related communication does not match any currently available media content, the search-related communication is then be sent to the media guidance data source 418 or another device or system.

In steps 1210 and 1212, the search-related communication is analyzed in an attempt to locate a currently unavailable media content that matches or is otherwise related to the search-related communication. The search-related communication may be analyzed by the media guidance application, the media guidance data source 418, or any other device or system. If a match is found in step 1212, the process continues to step 1214, otherwise it returns to step 1204.

Step 1214 determines whether the media content identified in steps 1204-1212 has been requested in at least a threshold number of other search-related communications. If the answer is no, the process returns to steps 1204-1212 until a threshold number of search-related communications identify a particular media content.

If the answer to step 1214 is yes, step 1216 then offers the identified media content to users of the media guidance application. The identified media content is preferably provided on an on-demand basis such as video-on-demand (VOD) or pay-per-view (PPV). An alert or notice may be sent to users of the media guidance application to inform them of the availability of the media content.

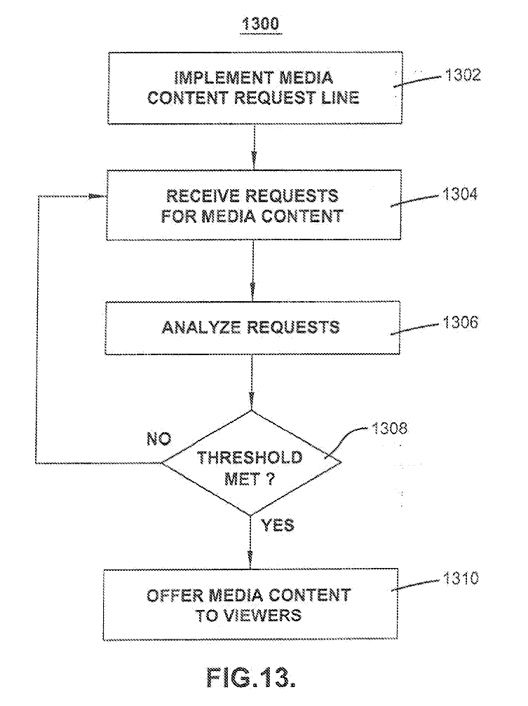

FIG. 13 shows another exemplary process 1300 for providing on-demand media content in response to user requests. In step 1302, a media content request line is established for receiving search-related communications. For example, a website such as www.requests.tvguide.com may be established to receive e-mail messages, text messages, instant messages and any other communications from mobile phones, computers, web-enabled portable devices, or any other suitable devices. The request line may also simply be an e-mail address, a regular mail address, or even a phone number.

In step 1304, a search-related communication is received at the request line. As mentioned above, the search-related communication may be any type of conventional communication.

In step 1306, the search-related communication is analyzed in an attempt to locate a media content that matches or is otherwise related to the search-related communication. The search-related communication may be analyzed by the request line, a device or system coupled with the request line, the media guidance data source 418, or any other device or system.

Step 1308 then determines whether the media content identified in step 1306 has been requested in at least a threshold number of other search-related communications. If the answer is no, the process reverts to steps 1304 and 1306 until a threshold number of search-related communications identify a particular media content.

If the answer to step 1308 is yes, step 1310 then offers the identified media content to users. The identified media content is preferably provided via the media guidance application on an on-demand basis such as video-on-demand (VOD) or pay-per-view (PPV). An alert or notice may be sent to users of the media guidance application to inform them of the availability of the media content.

Although the invention has been described with reference to exemplary embodiments illustrated and discussed herein, equivalents may be employed and substitutions made herein without departing from the scope of the invention as recited in the claims. For example, it will be appreciated that while the discussion of media content has focused on video content such as television programs, the principles of the present invention can be applied to other types of media content, such as music, images, etc. Similarly, the display screens 500, 600, 700, 800, 900, 1000, and 1100 shown in FIGS. 5-11 are merely illustrative and may be replaced with any suitable display screen arrangement. For example, instead of being displayed on dedicated screens, the various menu options may be displayed as opaque or translucent overlays over displayed media content.

Having thus described the preferred embodiment of the invention, what is claimed as new and desired to be protected by Letter Patent includes the following:

1. A method for providing on-demand media content, the method comprising the steps:
implementing on a plurality of user equipment devices a media guidance application having a media content search function;
receiving search-related communications from users of the media content search function;
analyzing the search-related communications to identify a media content not currently available via the media guidance application; and
once the media content has been identified from at least a threshold number of search-related communications, offering the media content on an on-demand basis via the media guidance application.

2. The method as set forth in claim 1, further including the step of alerting the users that the media content is available.

3. The method as set forth in claim 2, wherein the alerting step includes the step of sending a communication to the users via the media guidance application.

4. The method as set forth in claim 2, wherein the alerting step includes the step of sending a communication to the users via e-mail.

5. The method as set forth in claim 1, wherein the media content is a movie, the user equipment devices are television set-top boxes, and the media guidance application is an interactive television program guide implemented at least partially on the set-top boxes.

6. The method as set forth in claim 1, wherein the analyzing step includes the step of comparing the search-related communications to known media content titles in an attempt to locate a media content title that matches a portion of the search queries.

7. The method as set forth in claim 1, wherein the analyzing step includes the step of comparing the search-related communications to known media content topics in an attempt to locate a media content topic that matches a portion of the search queries.

8. The method as set forth in claim 1, wherein the search-related communications are search queries, keyword searches, e-mail messages, instant messages, or text messages, and wherein the search-related communications relate to a media content, an actor or celebrity featured in a media content, a director or producer of a media content, or a category of media content.

9. The method as set forth in claim 1, wherein the on-demand media content is video-on-demand (VOD), pay-per-view (PPV), or a broadcast program.

10. A method for providing on-demand media content, the method comprising the steps:
receiving search-related communications from a plurality of users of a media guidance application;
analyzing the search-related communications to identify a media content not currently available via the media guidance application; and
once the media content has been identified from at least a threshold number of search-related communications, offering the media content on an on-demand basis via the media guidance application.

11. The method as set forth in claim 10, wherein the search-related communications are e-mail messages, and wherein the search-related communications relate to a media content, an actor or celebrity featured in a media content, a director or producer of a media content, or a category of media content.

12. The method as set forth in claim 10, further including the step of alerting the users that the media content is available.

13. The method as set forth in claim 10, wherein the alerting step includes the step of sending e-mail messages to the users.

14. The method as set forth in claim 10, wherein the media content is a movie and the media guidance application is an interactive television program guide implemented at least partially on set-top boxes.

15. The method as set forth in claim 14, wherein the search-related communications are search queries entered into a media content search function of the media guidance application, and wherein the search-related communications relate to a media content, an actor or celebrity featured in a media content, a director or producer of a media content, or a category of media content.

16. The method as set forth in claim 15, wherein the analyzing step includes the step of comparing the search queries to known media content titles in an attempt to locate a media content title that matches a portion of the search queries.

17. The method as set forth in claim 15, wherein the analyzing step includes the step of comparing the search queries to known media content topics in an attempt to locate a media content topic that matches a portion of the search queries.

18. The method as set forth in claim 10, wherein the on-demand media content is video-on-demand (VOD), pay-per-view (PPV), or a broadcast program.

19. A system for providing on-demand media content, the system comprising:
control circuitry operable to implement a media guidance application having a media content search function;
control circuitry operable to receive search queries from users of the media content search function; and
a media source operable to—
analyze the search queries to identify a media content not currently available via the media guidance application; and
offer the media content on an on-demand basis to the users of the media guidance application once the media content has been identified from at least a threshold number of search queries.

20. The system as set forth in claim 19, the media source being further operable to alert the users when the media content is available.

21. The system as set forth in claim 20, wherein the media source provides the alert by sending a communication to the users via the media guidance application.

22. The system as set forth in claim 20, wherein the media source provides the alert by sending a communication to the users via e-mail.

23. The system as set forth in claim 19, wherein the media content is a movie, and the media guidance application is an interactive television program guide implemented at least partially by the control circuitry.

24. The system as set forth in claim 19, wherein the media source compares the search queries to known media content titles in an attempt to locate a media content title that matches a portion of the search queries.

25. The system as set forth in claim 19, wherein the media source compares the search queries to known media content topics in an attempt to locate a media content topic that matches a portion of the search queries.

26. The system as set forth in claim 19, wherein the media source is a media content source consisting of a television distribution facility, a cable system headend, or a satellite distribution facility.

27. The system as set forth in claim 19, wherein the media source is a media guidance data source that provides media guidance data to the media guidance application.

28. The system as set forth in claim 19, wherein the on-demand media content is video-on-demand VOD), pay-per-view (PPV), or a broadcast program.

29. A system for providing on-demand media content, the system comprising:
means for implementing a media guidance application having a media content search function;
means for receiving search-related communications from users of the media content search function;
means for analyzing the search-related communications to identify a media content not currently available via the media guidance application; and
means for offering the media content on an on-demand basis via the media guidance application once the media content has been identified from at least a threshold number of search-related communications.

30. The system as set forth in claim 29, further including means for alerting the users that the media content is available.

31. The system as set forth in claim 30, wherein the alerting means includes means for sending a communication to the users via the media guidance application.

32. The system as set forth in claim 30, wherein the alerting means includes means for sending a communication to the users via e-mail.

33. The system as set forth in claim 29, wherein the media content is a movie and the media guidance application is an interactive television program guide.

34. The system as set forth in claim 29, wherein the analyzing means includes means for comparing the search-related communications to known media content titles in an attempt to locate a media content title that matches a portion of the search queries.

35. The system as set forth in claim 29, wherein the analyzing means includes means for comparing the search-related communications to known media content topics in an attempt to locate a media content topic that matches a portion of the search queries.

36. The system as set forth in claim 29, wherein the search-related communications are search queries, keyword searches, e-mail messages, instant messages, or text messages, and wherein the search-related communications relate to a media content, an actor or celebrity featured in a media content, a director or producer of a media content, or a category of media content.

37. The system as set forth in claim 29, wherein the on-demand media content is video-on-demand VOD), pay-per-view (PPV), or a broadcast program.

38. A system for providing on-demand media content, the system comprising:
means for receiving search-related communications from a plurality of users of a media guidance application;
means for analyzing the search-related communications to identify a media content not currently available via the media guidance application; and
means for offering the media content on an on-demand basis via the media guidance application once the media content has been identified from at least a threshold number of search-related communications.

39. The system as set forth in claim 38, wherein the search-related communications are e-mail messages, and wherein the search-related communications relate to a media content, an actor or celebrity featured in a media content, a director or producer of a media content, or a category of media content.

40. The system as set forth in claim 38, further including means for alerting the users that the media content is available.

41. The system as set forth in claim 40, wherein the alerting means includes means for sending e-mail messages to the users.

42. The system as set forth in claim 40, wherein the media content is a movie and the media guidance application is an interactive television program guide implemented at least partially on set-top boxes.

43. The system as set forth in claim 42, wherein the search-related communications are search queries entered into a media content search function of the media guidance application, and wherein the search-related communications relate to a media content, an actor or celebrity featured in a media content, a director or producer of a media content, or a category of media content.

44. The system as set forth in claim 43, wherein the analyzing means includes means for comparing the search queries to known media content titles in an attempt to locate a media content title that matches a portion of the search queries.

45. The system as set forth in claim 43, wherein the analyzing means includes means for comparing the search queries to known media content topics in an attempt to locate a media content topic that matches a portion of the search queries.

46. The system as set forth in claim 38, wherein the on-demand media content is video-on-demand VOD), pay-per-view (PPV), or a broadcast program.
